(19) United States
(12) Patent Application Publication
(10) Pub. No.: US 2004/0213166 A1
(43) Pub. Date: Oct. 28, 2004

(54) Telecommunications network with automatic detection of the topology and method for this detection

(76) Inventor: Antonia Rambaldi, Arenzano (IT)

Correspondence Address: KIRSCHSTEIN, OTTINGER, ISRAEL, & SCHIFFMILLER, P.C., 489 FIFTH AVENUE, NEW YORK, NY, 10017

(21) Appl. No.: 10/475,897

(22) PCT Filed: Apr. 25, 2002
(86) PCT No.: PCT/IB02/02781

(30) Foreign Application Priority Data
Apr. 30, 2001 (IT) MI01A000900

(51) Int. Cl. H04L 12/28

(52) U.S. Cl. 370/254; 370/400

(57) ABSTRACT

A telecommunications network with system for automatic detection of the topology of the network or of a sub-network thereof, comprises a plurality of network elements or nodes linked together to establish communications trails with termination points in ports of elements of the plurality of network elements. Each termination point is assigned a unique address in the network or in the sub-network and the corresponding network element sends along the outgoing trail from the termination point a message representing the unique address assigned and which is intended for the termination point at the other end of the trail. Each network element at either end of a communication trail therefore receives the message representing the address of the termination point of the element at the other end. In this way, each termination point of a connection will have received in the message the information that identifies the other termination point to which it is connected. A method for automatic detection of the topology of the network is also described.

The present invention refers to a telecommunications network with automatic detection of the topology of a network. In particular, the network can for example be of the SDH or DWDM type. The invention also refers to a method for performing this detection.

Generally a telecommunications network can be modelled like a mesh comprising nodes and links. A node is an optical element of the network, which contains physical interfaces, hereafter referred to as ports. A link between two compatible ports belonging to two nodes is set up using a passive physical connection (fibre) and is referred to as a “physical path”.

A mesh of this type exists in all the layers supported by the network elements of which it is composed. The form of the mesh may vary from layer to layer since in each layer the links (or communications trails) have a different significance. Thus, for example, in the physical layers the mesh shows the physical topology of the network, while in other layers of the SDH system the links signify the logical adjacency between nodes, where two nodes are adjacent if and only if a server trail connects them.

More generally, and in line with the view put forward by the standards, the network elements contain trail termination points (TTP's) and two TTP's are connected by a trail.

In the known technique, some information on the topology of the network and which is exchanged by the TTP's, is set manually following the physical creation of the network itself, with the mnemonic strings being memorised within the nodes, each associated with a particular connection. These strings, referred to as “trace identifiers”, are for example formed by a conventional name that is given by the operator performing the setting of the apparatus, so that he can recognise the port when setting the other end of the connection. In other words, these trace identifiers are only used to carry some unique trail identifiers and they are used for the purpose of detecting connection errors in the network. The connection errors are detected both initially in manual mode (when the operator sets the other head of the connection) and then automatically. In practice, if the receiving apparatus does not receive on a TTP the string specified for that connection by the operator, an alarm is activated.

For example, for both the SDH and DWDM technologies a certain number of trace identifiers are defined. These are exchanged between TTP's and contain a fixed number of bytes. Within the context of the processing of these trace identifiers, a certain number of standard behaviours are implemented in the network elements.

Until now these trace identifiers have been processed by the telecommunications management networks (TMN) systems and for this reason only two possible behaviours are identified in the standards.

The first does not provide for the processing of these, meaning that a fixed byte with a fixed value is sent between termination points. The associated behaviour is unimportant, the byte simply being sent and received.

In the second case, each termination point sends a specific string of bytes, in principle 16 bytes, and the TMN system sets this string (established at the outset by the operator). TMN's can also set a string of bytes to be used as anticipated trace identifiers. The TMN system can read the trace identifier received. An alarm is raised in the event that the TNM sets an anticipated trace identifier and the network element realizes that the trace identifier received is different from the one anticipated.

It can be seen how such a method of proceeding allows information to be obtained on the trail but not on the actual termination points at the end of this trail, which are not identified in an absolute manner.

The general aim of this invention is to avoid the abovementioned disadvantages by providing a method and a network for telecommunications with automatic detection of the topology.

In view of this aim consideration was given to creating, according to the invention, a telecommunications network with a system for the automatic detection of the topology of the network or of a sub-network thereof, that comprises a plurality of network elements or nodes connected together to establish communications trails with termination points in ports of elements of the plurality of network elements, with each termination point being assigned a unique address in the network or in the sub-network and the corresponding network element emitting on the output trail from the termination point a message representing the unique address assigned and which is directed to the termination point at the other end of the trail, with each network element at one of the two ends of a communication trail therefore receiving the message representing the address of the termination point of the element at the other end, such that each termination point of a connection will have received in the message the information to identify the other termination point to which it is connected.

In order to provide a clearer explanation of the innovative principles of this invention and its advantages over prior art, in the following a possible design is described that applies these principles.

In order to do this use is also made of the attached drawings, in which:

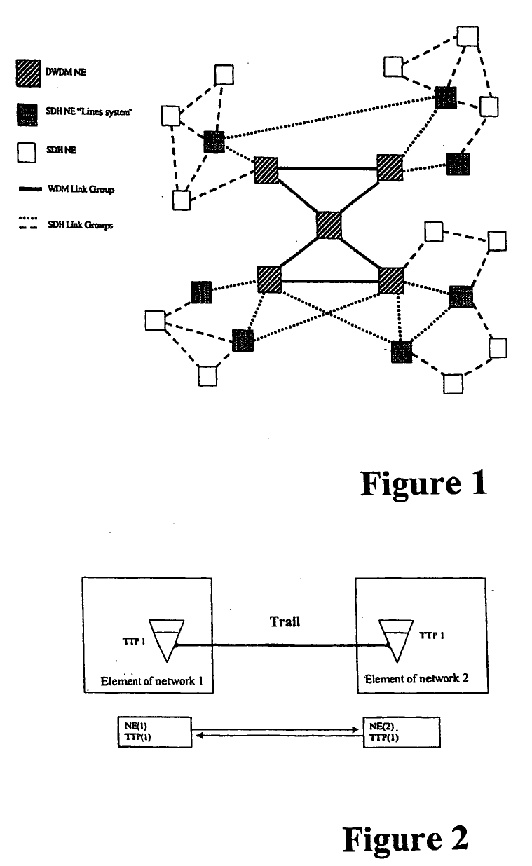

FIG. 1 shows a mesh defining a network;

FIG. 2 shows two network elements, each with a termination point for a communication trail, and the possible exchange of address messages between them;

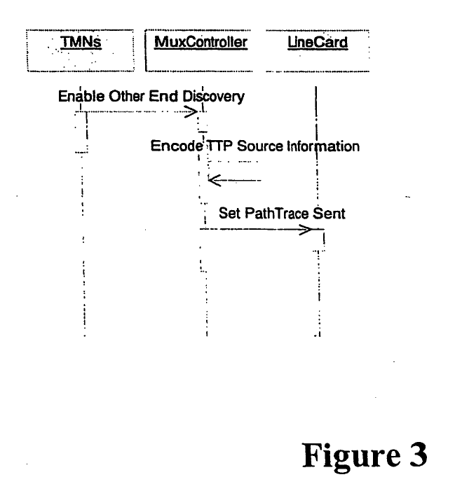

FIG. 3 shows a diagram that illustrates a preferred sequence of events when it is decided to change to automatic detection of the topology.

In the following reference is made to either nodes or to the network elements making up these nodes. Within the elements or nodes there are ports that constitute termination points at the end of communication trails. All this is well known to a technician skilled in the art and will not be described or illustrated further here.

FIG. 1 shows a mesh of a possible network topology, illustrating DWDM network elements, SDH network elements constituting line systems and SDH network elements, all with the respective connections.

In order to provide the automatic discovery of the topology of the network each TTP needs to have the information on its counterpart at the other end of the trail. In order to have this information it is necessary for there to be a communications channel that allows it to identify its correspondent at the other node.

The telecommunication network with the system for automatic detection of the topology of the network itself (or also of a sub-network of this) comprises as stated a plurality of network elements or nodes linked together in order to establish communications trails with termination points in ports of elements of the plurality of network elements.

Each termination point is assigned a unique address in the network or in the sub-network and the corresponding network element emits onto the output trail from the termination point a message representing the unique address assigned and which is directed to the termination point at the other end of the trail.

Each network element at either end of a communication trail thus receives the message representing the address of the termination point of the element at the other end. In this way, each termination point of a connection will have received in the message the information that identifies the other termination point to which it is connected.

This is shown schematically in FIG. 2 which illustrates, in the bottom part, the messages exchanged. In the example shown, as will be clear from the following, the messages exchanged comprise an identifier of the network element (NE1 or NE2) and an identifier of the termination point within the element (TTP1 or TTP2).

It is, of course, necessary to identify a communication channel on which the exchange of address messages takes place.

By using SDH and DWDM type networks, the same trace identifiers can be used as already mentioned above in relation to prior art, adding or substituting new behaviours for the standard ones.

The signalling channel, as stated above, can therefore be created using these trace identifiers.

In more detail, a new behaviour has to be implemented by the network elements. This new behaviour requires trace identifiers of a coded string containing the information necessary for unique identification of the source TTP of the trail to be sent in the bytes. If this is implemented in both end points of the trail the result will be that each termination point will have received in the trace identifier the information on the other end point. As a result of this, each node is aware of which other node is connected to each of its ports.

At the level of the network (or of a sub-network), all the network elements are in a position to know the counterpart connected to each of their own ports.

The information that should be sent by each of the end points is as follows:

The node identifier, set for the node at the time of construction or installation.

This can also, for example, be the IP address of the node.

The TTP identifier, this may be created automatically by the node which knows where the TTP is. A possible advantageous system of location for a physical TTP could be the “shelf, slot and port” supporting the TTP. For other types of TTP other information may be added, for example in the case of a TTP in the AU4VC4 trail layer the information to be added could be the AU4 identifier.

So, in a general manner, each TTP will send the “node id”—“TTP id” pairing and will receive the same pairing from the remote TTP, as shown in the above-mentioned FIG. 2. In other words, in order to identify the resources involved in the topology of the network each node of the network is identified using a unique name and each termination point of a trail is named using an identifier that is unique within the context of the node.

The technique described here does not require modifications to the hardware of the network elements or to the firmware present on the cards supporting the TTP's. All the work for coding and decoding the trace identifier can be performed on the “mux controller” without the addition of a significant processing load, as can easily be imagined by an expert technician.

In order to achieve this, the mux controller must send on the line card the trace identifier in a ready-coded form (both for that “sent”) and, where requested, that “anticipated”) that will be treated as a normal string by the line card, in this way retaining the behaviour of the line card.

FIG. 3 shows a diagram that illustrates the sequences of events when a user decides to switch to automatic detection of the topology.

With the algorithm described both the end points of the section are aware of their counterpart.

It is easy for an expert technician to imagine how this technique can be extended for the purpose of detecting bad connections in the network. In order to do this, following automatic discovery the user can request that the trace identifier received is copied in the one anticipated. Following this operation the topology of the network is frozen and any subsequent error in the connection will be detected.

What has been described can be applied in a large number of cases and at various levels of the networks formed by a set of layers, as is the case with SDH and DWDM networks.

In more detail, according to the layer there will be:

SR layer: the J0 bytes are used for the purpose of discovering the physical network topology of SDH networks.

AU4VC4: the J1 bytes are used for the purpose of discovering the adjacencies of the network created from the VC4 trails.

Circuit layers TU3VC3, TU2VC2, TU12VC12: the J2 bytes are used for the purpose of discovering the trails used in the network and which are the topology for the “PDH client network”.

OTS layer: the trace bytes of the section are used in order to discover the topology of the DWDM network.

OCH layer: the trace bytes present in the “digital wrapper” are used for the purpose of discovering the sections configured in this layer and which are the topology for the SDH client network.

For each of these applications a TTP identifier can be created using the information that is significant in the particular case.

So, for the application in the physical transmission layers (RS, OTS), the TTP identifier can be based on the physical coordinates of the port. These can be shelf, slot and port identifiers.

For the applications in trail layers (AU4VC4), the TTP identifier can be a concatenation of the previous set and of the channel identifier (AU4Id or, better, AUGId).

For applications in the OCH layer, the TTP identifier can be created by always starting from the physical coordinates and adding information on the two frequencies of the channel of origin ●source and ●sink taken as an index in a fixed table of frequencies.

Possible and preferred descriptions of the formats to be used in the protocol for the automatic discovery of the topology according to the invention for the applications described above are shown in the following tables.

For SDH RS, TU3CV3, TU2CV2, TU12VC12 and DWDM OTS protocols, based on the fact that there are sixteen bytes exchanged with the trace identifier, a possible coding scheme might be:

| Byte | Value |
|---|---|
| 0 | Protocol identifier: Ox01 |
| 1 | Node identifier comprising 4 bytes. This can also be the node IP |
| 2 | address. |
| 3 | |
| 4 | |
| 5 | Shelf identifier |
| 6 | |
| 7 | Slot identifier |
| 8 | |
| 9 | Port identifier |
| 10 | |
| 11 | Fixed value OxFF <RESERVED> |
| 12 | Fixed value OxFF <RESERVED> |
| 13 | Fixed value OxFF <RESERVED> |
| 14 | Fixed value OxFF <RESERVED> |
| 15 | Checksum byte |

In the case of SDH AU4CV4 protocols (always with 16 bytes for the trace identifier), the coding scheme could advantageously be:

| Byte | Value |
|---|---|
| 0 | Protocol identifier: Ox02 |
| 1 | Node identifier comprising 4 bytes. This can also be the node IP |
| 2 | address. |
| 3 | |
| 4 | |
| 5 | Shelf identifier |
| 6 | |
| 7 | Slot identifier |
| 8 | |
| [symbol] | Port identifier |
| [symbol] | |
| 11 | AUID |
| 12 | |
| 13 | Fixed value OxFF <RESERVED> |
| 14 | Fixed value OxFF <RESERVED> |
| 15 | Checksum byte |

In the case of DWDM OCH protocols (always with 16 bytes for the trace identifier), the following could be advantageous:

| Byte | Value |
|---|---|
| 0 | Protocol identifier: Ox03 |
| 1 | Node identifier comprising 4 bytes. This can also be the node IP |
| 2 | address. |
| 3 | |
| 4 | |
| 5 | Shelf identifier |
| 6 | |
| 7 | Slot identifier |
| 8 | |
| 9 | Port identifier |
| 10 | |
| 11 | •source identifier |
| 12 | |
| 13 | •sink identifier |
| 14 | |
| 15 | Checksum byte |

In order to handle the new behaviour according to the invention of the various trace identifiers, certain modifications are needed to the so-called information model as defined in the standards. With what is stated above, the modifications are easy for an expert technician to imagine. For example, in the case of SDH networks the syntax of path trace from G774 should be modified as follows:

PathTrace ::=CHOICE{

| | | | | |
|---|---|---|---|---|
| | null | NULL, | | |
| | pathtrace | [1] | GRAPHICSTRING | |
| | other-end | [2] | TTP location | - new branch |
| } | | | | |

TTPLocation ::=SEQUENCE {

| | | |
|---|---|---|
| | networkElement | INTEGER, |
| | shelf | INTEGER, |
| | slot | INTEGER, |
| | port | INTEGER |
| | aug | INTEGER OPTIONAL |
| } | | |

At this point it is clear how the predefined aims are achieved.

It must be noted that the technique described above achieves the aims of the invention without the introduction of modifications to the apparatus hardware or modifications to the software of the line cards used in the network, if these are pre-existing. Only minor and quite localised modifications are needed to the controller card. In other words a pre-existing network can be easily transformed into the network according to the invention, or into a network that applies the method according to the invention with limited modifications and that require relatively little time and expense.

Of course, the above description given of a design that applies the innovative principles of this invention is given by way of an example of these innovative principles and must therefore not be taken as limiting the scope of the patent right claimed here.

For example, it could be suggested that the modifications be made in the network element since in this way both the local controller and the TNM can use its advantages. Other solutions can however be used. In order to reduce the load that must be placed on the software of the network element the same technique can be implemented in the TNM system. In this case the TNM will calculate the coded strings for the trace identifiers and will set these on the network element.

Using these algorithms in coordination with the TNM the entire topology of the network can be loaded automatically from the network. This frees the TNM operator from losing time on the creation of the sections.

What is described above can be used without changes in the SDH and DWDM network elements and can be applied to all the layers in which these network elements operate (transmission media layers, path layers, circuit layers).

1-13. (Canceled)

14. A telecommunications network with a system for automatic detection of a topology of the network or of a sub-network thereof, comprising: a plurality of network elements or nodes linked together in order to establish communication trails with termination points in ports of elements of the plurality of network elements, each termination point being assigned a unique address in the network or in the sub-network, the corresponding network element emitting on an output trail from the termination point a message representing the unique address assigned and which is directed to the termination point at the other end of the trail, each network element at either end of a communication trail thus receiving the message representing the unique address of the termination point of the network element at the other end of the communication trail, and each terminal point of a connection receiving in the message information identifying the other terminal point to which it is connected.

15. The network according to claim 14, in that the message is contained in a trace identifier of a communication standard of the network.

16. The network according to claim 14, in that the unique address is formed by a unique identifier of the node or network element in the network or sub-network, and by a relative identifier of the terminal point of the node or network element.

17. The network according to claim 16, in that the relative identifier of the terminal point comprises three items of information identifying a shelf, a slot and a port of the network element.

18. The network according to claim 16, in that the unique identifier of the node or network element is an internet protocol address of the node.

19. The network according to claim 14, in that the network is a synchronous digital hierarchy and dense wavelength division multiplex network.

20. The network according to claim 19, in that for the automatic detection of a physical topology of the network, the message is contained in J0 bytes of an RS layer.

21. The network according to claim 19, in that for the automatic detection of the topology of logical adjacencies of the network, the message is contained in J1 bytes of AU4VC4 layers.

22. The network according to claim 19, in that for the automatic detection of the topology of the trails implemented in a plesiochronous digital hierarchy network, the message is contained in J2 bytes of a TU3VC3, TU2VC2, TU12VC12 layer.

23. The network according to claim 19, in that for the automatic detection of the topology of the dense wavelength division multiplex network, the message is contained in section trail bytes of an optical transmission section layer.

24. The network according to claim 19, in that for the automatic detection of the topology of the synchronous digital hierarchy network, the message is contained in trace bytes of an optical channel layer.

25. The network according to claim 24, in that, in the optical channel layer, a trail termination point identifier is created by adding to physical coordinates of the trail termination point information on two frequencies of a channel of source and sink origin, taken as an index in a fixed table of frequencies.

26. A method of automatically detecting a topology of a network or of a sub-network, that has a plurality of network elements or nodes linked together to establish communication trails with termination points in ports of elements of the plurality of network elements, comprising the steps of: assigning to each termination point a unique address in the network or in the sub-network, instructing the corresponding network element to emit on an output trail from the terminal point a message representing the unique address assigned and which is directed to the termination point at the other end of the trail, each network element at either end of a communication trail receiving the message representing the unique address of the termination point of the element at the other end of the communication trail, and extracting from the message received at the termination point information identifying the other terminal point to which it is connected.
